(19) United States
(12) Patent Application Publication
(10) Pub. No.: US 2015/0112801 A1
(43) Pub. Date: Apr. 23, 2015

(54) MULTIPLE PERSONA BASED MODELING

(71) Applicant: MICROSOFT CORPORATION, REDMOND, WA (US)

(72) Inventors: NIR NICE, KFAR VERADIM (IL); NOAM KOENIGSTEIN, RAANANA (IL); ULRICH PAQUET, CAMBRIDGE (GB); SHAHAR ZVI KEREN, HEMED (IL)

(73) Assignee: MICROSOFT CORPORATION, REDMOND, WA (US)

(21) Appl. No.: 14/059,891

(22) Filed: Oct. 22, 2013

(51) Int. Cl. G06Q 30/02

(52) U.S. Cl. CPC G06Q 30/0255; G06Q 30/0269
USPC 705/14.53

(57) ABSTRACT

Matrix factorization techniques may be employed to identify different tastes based on user history information for a user profile and to provide item recommendations for the various tastes. An item model may be generated that includes item vectors, each item vector representing an item from a catalog of items. An item vector from the item model may be identified for each of a number of items identified in information for a user profile. The item vectors may be grouped into different clusters, and a taste vector may be generated for each cluster based on item vectors in each cluster. Each taste vector may be used to select item recommendations that may be combined in a set of recommendations provided for presentation to one or more users associated with the user profile.

### BACKGROUND

Recommendation systems help predict user interest in various products or services. As a result, recommendation systems have become extremely common in a variety of product and service environments, such as product shopping websites, music delivery services, and video delivery services, to name a few. A number of different approaches have been employed by various recommendation systems to provide recommendations to users.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to analyzing user history information from a user profile to implicitly identify multiple tastes and provide recommendations for the various tastes. In accordance with some embodiments, matrix factorization may be employed to generate an item model with item vectors representing items from a catalog of items. Item vectors may be identified for items identified in user history information for a use profile. The item vectors may be grouped into clusters, and a taste vector may be generated for each cluster based on the item vectors in the cluster. The taste vectors may be used to select item recommendations to include in a set of recommendations, which may then be provided for presentation to one or more users associated with the user profile.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system architecture in which embodiments of the invention may be employed;

FIG. 3A is a diagram of a latent space model illustrating an example in which three taste vectors have been generated based on multiple persona based modeling in accordance with an embodiment of the present invention;

FIG. 3B is a diagram of a latent space model illustrating an example in which only a single user model vector has been generated;

FIG. 4 is a flow diagram showing an overall method for employing multiple taste vectors to provide item recommendations in accordance with an embodiment of the present invention;

FIG. 5 is a flow diagram showing a more detailed method for generating multiple taste vectors for a user profile and employing the multiple taste vectors to provide item recommendations in accordance with an embodiment of the present invention; and

FIG. 6 is a flow diagram showing a method for generating taste vectors for item recommendation selection based on a time at which the item recommendations are being provided to a user in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

While recommendation systems have been widely used in a variety of settings to recommend products and services to users, there are a number of situations in which recommendation systems may fail to provide robust recommendations. For instance, recommendations are often provided based on usage information for a user profile or account (“user profile” or “user account” will be used herein to reflect any profile, account, or other mechanism that tracks information for a user or group of users or otherwise allows a user or group of users to access a service for which recommendations may be given). However, in many cases, there is more than one person behind a single user profile. As a specific example, one user profile may be used by a family for a video-streaming service. As a result, the usage for the user profile reflects all videos viewed by the family, including videos viewed by the parents and children. When recommendations are selected based on usage from such a user profile, the recommendations may be a blend or average of the usage habits of all people behind the user profile, which may result in poor recommendations.

Even in cases in which there is only one person behind the user profile, the person may have different tastes that are reflected in the person's usage habits. For example, a user may watch sports on Sunday evening, comedies on weekdays, and dramas on weekends. Basing recommendations on this usage may result in recommendations that are some type of an average of all these tastes, which may be poor and insufficient.

One approach that some recommendation systems have taken is to require users to explicitly associate usage patterns to different individuals. For instance, in the case in which a family shares a single account for a video-streaming service, the family may explicitly associate videos watched by different family members with different personas or sub-profiles. However, this can be time-consuming and cumbersome to users. Another approach may be to maintain separate sub-profiles and to identify which sub-profile is being used when consuming items. Again, this may be cumbersome to some users and is prone to error as the wrong sub-profile could be selected inadvertently.

Embodiments of the present invention provide for, among other things, multiple personas or tastes to be identified by processing usage habits of a user profile without requiring a user to specify any information regarding which persona consumed each item. By identifying multiple tastes based on usage habits for a user profile, recommendations may be provided that are particularly tailored to each taste. For instance, in the example above in which a family shares an account at a video-streaming service, analysis of the usage habits for the family's user profile may result in the identification of two tastes—one for the parents, and one for the children. In the example above in which a user watches sports on Sunday evening, comedies on weekdays, and dramas on weekends, three different tastes may be identified that could result in sports recommendations, comedy recommendations, and drama recommendations. Additionally, the recommendations may be weighted based on the usage patterns such that the recommendations are somewhat proportional to the usage habits for the user profile. Further, the recommendations may be time-based, such that sports recommendations may be prevalent when recommendations are provided on Sunday evenings, comedy recommendations may be more prevalent when recommendations are provided on weekdays, and drama recommendations may be more prevalent when recommendations are provided on weekends (other than Sunday evening).

In accordance with embodiments of the present invention, different tastes may be identified for a user profile using item-to-item relationships that may be defined by a metric, heuristic, or other approach that identifies item similarity or relatedness. In some embodiments, matrix factorization may be employed although other techniques may be used within the scope of embodiments of the present invention. This may include using matrix factorization to initially generate an item model in which each item from a catalog of items (e.g., movies from a movie-streaming service) is represented as an item vector in a multi-dimensional latent space. To identify tastes for a user profile, historical usage information for a user profile is accessed to identify items consumed by one or more users associated with the user profile. Item vectors are identified for each of those items, and the item vectors are grouped into clusters. Each cluster corresponds with a taste for the user profile, and a taste vector is generated for each cluster based on the item vectors in the cluster. Recommendations may then be selected for each taste vector independent of the other taste vectors. As a result, the recommendations selected for a particular taste vector will correspond with a particular taste identified from the usage habits of the user profile. The recommendations for the taste vectors may then be combined in a variety of different manners to produce a set of recommendations that are then provided for presentation to user(s) associated with the user profile. As a result, the recommendations may accurately reflect the various tastes associated with a single user profile.

Accordingly, in one aspect, an embodiment of the present invention is directed to one or more computer storage media storing computer-useable instructions that, when used by one or more computing devices, cause the one or more computing devices to perform operations. The operations include generating an item model using matrix factorization and user history information for a plurality of users profiles. The item model includes a plurality of item vectors, each item vector representing an item. The operations also include accessing user history information identifying a plurality of items for a first user profile. The operations further include employing information from the item model and user history information to group item vectors corresponding with the plurality of items from the user history information into one or more clusters of item vectors. The operations also include generating a taste vector for each cluster of item vectors to provide one or more taste vectors and identifying one or more item recommendations for each taste vector. The operations further include providing a set of item recommendations based on the one or more item recommendations for each taste vector and providing the set of item recommendation for presentation to a user associated with the first user profile.

In another embodiment of the invention, as aspect is directed to a method. The method includes employing, via a first computing process, matrix factorization to represent a user profile with one or more vectors. The method also includes identifying, via a second computing process, a plurality of item recommendations employing the one or more vectors. The method further includes providing, via a third computing process, at least a portion of the item recommendations for presentation to a user associated with the user profile. The computing processes are performed by one or more computing devices.

A further embodiment is directed to a computerized system that includes one or more processors and one or more computer storage media storing a plurality of software components, including an item model component, an item vector clustering component, a taste vector component, and a recommendation component. The item model component generates an item model comprising a plurality of item vectors using matrix factorization on user history information for a plurality of users. The item vector clustering component employs information from the item model and information from a user profile to group item vectors into one or more clusters of item vectors. The taste vector component generates a taste vector for each cluster of item vectors to provide at least two taste vectors for the user profile. The recommendation component that provides at least one recommendation for each taste vector.

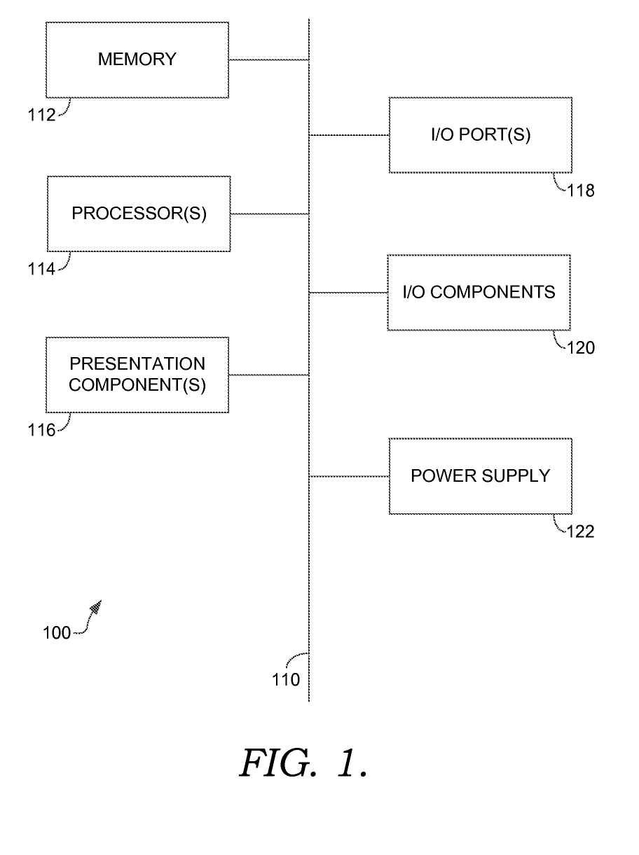

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc. The I/O components 120 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

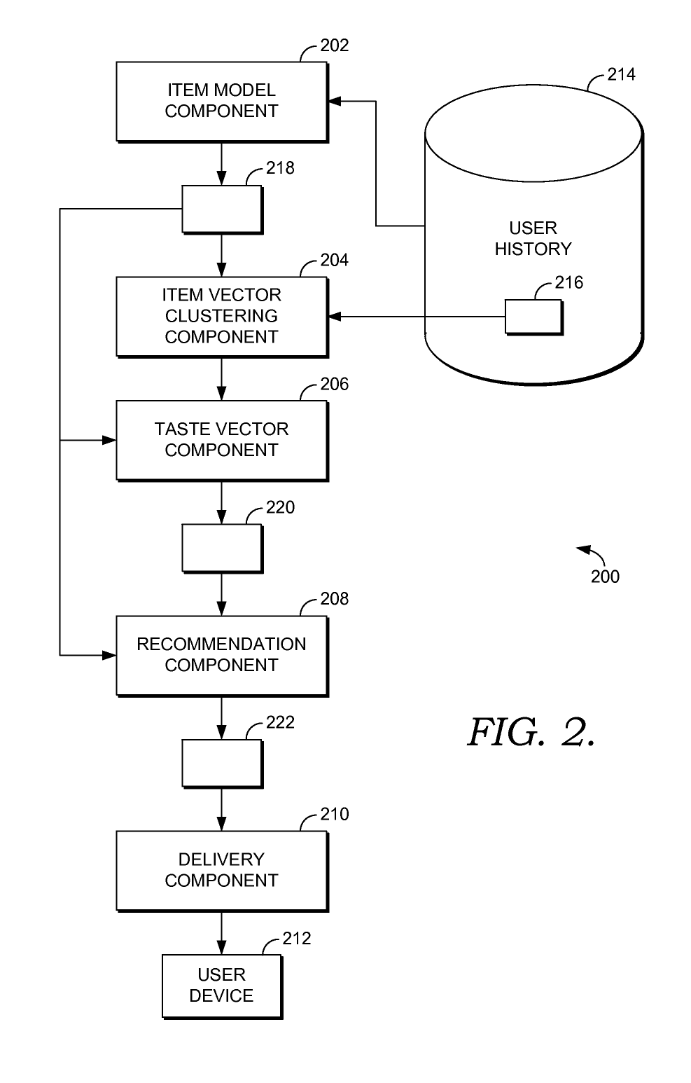

Turning now to FIG. 2 a block diagram is provided illustrating an exemplary system 200 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 2, the system 200 includes an item model component 202, an item vector clustering component 204, a taste vector component 206, a recommendation component 208, and a delivery component 210. It should be understood that the system 200 shown in FIG. 2 is an example of one suitable computing system architecture. The system 200 may include one or more computing devices similar to the computing device 100 described with reference to FIG. 1. The system 200 should not be interpreted as having any dependency or requirement related to any single module/component or combination of modules/components illustrated therein. Each may comprise a single device or multiple devices cooperating in a distributed environment. For instance, components may comprise multiple devices arranged in a distributed environment that collectively provide the functionality described herein. Additionally, other components not shown may also be included within the network environment.

The item model component 202 generally operates to generate an item model 218 using matrix factorization. Any of a number of different matrix factorization techniques may be employed to generate the item model 218. Such techniques are known to one skilled in the art and will not be described in further detail herein. The item model 218 includes an item vector in a latent space for each of a number of different items from a catalog of items. It should be understood that embodiments of the present invention may operate on any type of item for which recommendations may be provided. By way of example only, the items may be videos (e.g., television shows, movies, music videos, etc.), audio (e.g., songs, podcasts, etc.), products, and services, to name a few.

In accordance with some embodiments of the present invention, the item model component 202 may generate the item model 218 based on user history information for a number of different user profiles. For instance, the system 200 may include a user history datastore 214 storing user history information for a number of user profiles (including user profile 216 shown in FIG. 2). The user history information for each user profile may include information regarding items consumed by one or more users associated with the user profile. Consumption of an item may include any type of interaction by a user with an item that provides an indication the user may be interested or disinterested in the item, such as, for instance, purchasing, renting, downloading, streaming, providing a review, and/or providing an indication of an item as a “like” or “dislike.”

While FIG. 2 illustrates an embodiment in which user history information is employed by the item model component 202 to generate the item model 218, it should be understood that other information may be used in addition to or in lieu of user history information. For instance, in some embodiments, the item model component 202 may employ metadata about items to generate an item model in which items are represented by item vectors in a latent space. The metadata may include any information about the items beyond user history/interaction information, such as, for instance, descriptions, categorizations, or specifications of items. By way of example to illustrate, metadata for a movie may include the movie genre (e.g., drama, comedy, honor, action, etc.) to which the movie belongs. It should be noted, though, that such item metadata is not necessary and embodiments of the present invention are capable of operating to select item recommendations without the use of any item metadata by relying only on user history information.

As noted above, the output from the item model component 202 is an item model 218 that includes item vectors for a number of different items, each item vector providing a representation of a corresponding item in a latent space. Item vectors from the item model 218 may be employed in accordance with embodiments of the present invention to generate taste vectors for a user profile to represent the various tastes or interests of one or more users associated with the user profile. Generally, the item vectors for items from the user history for a user profile may be employed to generate the taste vectors for the user profile. For instance, in the embodiment shown in FIG. 2, taste vectors are to be generated for the user profile 216, which may one of many user profiles stored in the user history datastore 214. The user profile 216 may identify items that one or more users associated with the user profile have somehow interacted with or otherwise provided some indication of interest or disinterest in the items. An item vector clustering component 204 may identify items from the user history for the user profile 216 and identify item vectors for each of those items from the item model 218. The item vector clustering component 204 operates to group those item vectors into one or more clusters. A variety of different clustering techniques may be employed to generate the clusters of item vectors. One particular technique will be described in further detail below, but it should be understood that other clustering techniques may be employed within the scope of embodiments of the present invention.

Based on the clusters of item vectors from the item vector clustering component 204 using the item model 218, the taste vector component 206 generates taste vectors 220 for the user profile 216. Each taste vector corresponds with one of the item vector clusters. For instance, if three item vectors clusters are output by the item vector clustering component 204, the taste vector component 206 may output three taste vectors. A taste vector may be generated, for instance, as an average of the item vectors from a cluster.

The taste vectors 220 are employed by the recommendation component 208 to generate a set of item recommendations 222. The recommendation component 208 may identify item recommendations for each taste vector independently of each of the other taste vectors. The item recommendations for a taste vector may be identified using the taste vector and item vectors from the item model 218 generated by the item model component 202. For instance, items may be ranked for a taste vector by computing the dot-product between the taste vector and each of a number of different item vectors from the item model. Item recommendations may be selected based on the dot-product results. The higher the dot-product result computed using an item vector for an item, the more relevant the item may be considered to the taste vector. Accordingly, one or more item recommendations may be selected for a taste vector based on the rankings. It should be understood that other factors may also be taken into consideration when selecting item recommendations.

The output from recommendation component 208 is a set of item recommendations 222 that includes item recommendations selected for each of the taste vectors 220. The set of item recommendations 222 may include any mix of item recommendations selected for each of the taste vectors 220. In some embodiments, the set of item recommendations 222 may include an equal number of item recommendations for each taste vector. In other embodiments, weighting may be applied that may result in providing more item recommendations for some taste vectors than other taste vectors. The weighting may be based on any number of factors. For instance, the weighting may be based on the number of item vectors included in each cluster used to generate each taste vector. Accordingly, a taste vector generated from a larger cluster of item vectors may be given greater weighting so more item recommendations from that taste vector are included in the set of item recommendations 222.

As another example, weighting may be based on the strength or popularity of individual items represented by item vectors included in each cluster. The strength or popularity of an item could be based, for instance, on the number of users that have consumed the item or user review/ratings of the item (e.g., number of stars given by users).

As a further example, weighting may be based on time at which the set of item recommendations 222 are being provided and times at which items from the user history for the user profile 216 have been consumed. This may be done by tracking the times at which items are consumed by one or more users associated with the user profile 216 and storing the time information in the user profile 216 with each item. Any measure of time could be stored in the user profile 216, such as, for instance, day of the week or time of day. By tracking when items are consumed and applying time-based weightings, item recommendations may be based on the viewing habits associated with the user profile 216 and reflect times at which each taste vector is more active. For instance, suppose that the user profile 216 is for a video streaming service and is associated with a family that includes parents and children. The children typically watch cartoons in the afternoon and the parents typically watch dramas in the evenings. Therefore, by using weightings that take the time at which item recommendations are being given and times at which items from the user profile 216 were consumed, item recommendations that include videos similar to the cartoons watched by the children may be provided if the item recommendations are provided in the afternoon and item recommendations that include videos similar to the dramas watched by the parents may be provided if the item recommendations are provided in the evening.

An alternative to generating taste vectors generally and then applying time-based weightings when selecting recommendations would be to initially generate taste vectors based on time. In particularly, a time period could be selected and only items that have been consumed during that time period are selected and used by the item vector clustering component 204 to generate item vector clusters. Thus, the taste vectors 220 generated by the taste vector component 206 and the set of recommendations 222 selected for those taste vectors 220 by the item recommendation component 208 in this embodiment would correspond with the particular time period since they are built around items consumed during that time period. For instance, continuing the example above in which the user profile 216 is for a video streaming service for a family in which the children watch cartoons in the afternoon and the parents watch dramas in the evening, suppose the item recommendations are being given at 3:00 pm. Based on that time, a time period may be selected. For instance, the time period from 2:00 pm to 4:00 pm may be selected and items consumed during that time period may be identified from the user profile 216. Assuming that those items are all videos the children have watched in the past, the taste vectors generated and item recommendations selected based on those items may reflect different tastes for the children. Additionally, the item recommendations given at that time may not be affected by the videos watched by the parents since the parents never watch videos during that time period.

It should be understood that selection of a time period for selecting items from the user profile 216 for generating time-based item recommendations may be done in a variety of different manners. In some embodiments, the selection of a time period and generation of taste vectors may be done in real-time when item recommendations are being given. In other embodiments, a number of different time periods may be selected as a part of background processing to generate taste vectors for each time period, and a set of taste vectors may be stored for each time period. Then, when item recommendations are being provided, taste vectors for that time period may be retrieved from storage and used to select item recommendations.

The item recommendations identified for the taste vectors 220 may be combined in the set of item recommendations 222 in any of a number of different manners. In some embodiments, the item recommendations may be separated out into groupings based on the taste vectors. For instance, if three taste vectors were identified, the set of item recommendations 222 may include three separate groups of item recommendations grouped by taste vector. In other embodiments, the item recommendations from the taste vectors may be commingled together. A single set of item recommendations could be provided or separate groupings of item recommendations could be provided with item recommendations from different taste vectors commingled together. The separate groupings could be based on some criteria other than the taste vectors. For instance, item recommendations may be grouped based on metadata associated with the items. As a specific example, movies could be grouped by movie genre.

Item recommendations may also be ranked and ordered within the set of item recommendations 222 using any of a number of different factors. For instance, each item recommendation may be ranked based on the strength of relevance of an item to one of the taste vectors (e.g., based on the dot-product as discussed above) or based on the strength or popularity of the item. As noted above, the strength or popularity of an item could be based, for instance, on the number of users that have consumed the item or user review/ratings of the item (e.g., number of stars given by users).

The set of item recommendations 222 is provided to a user device 212 by a recommendation delivery component 210 for display to user(s) associated with the user profile. Item recommendations may be delivered to user devices in any of a variety of different settings in accordance with embodiments of the present invention. By way of example only and not limitation, item recommendations may be delivered: to an application used to consume items (e.g., a video streaming app, music streaming app, etc.), on a webpage (e.g., a user profile webpage of a web service used by the user), or via an email.

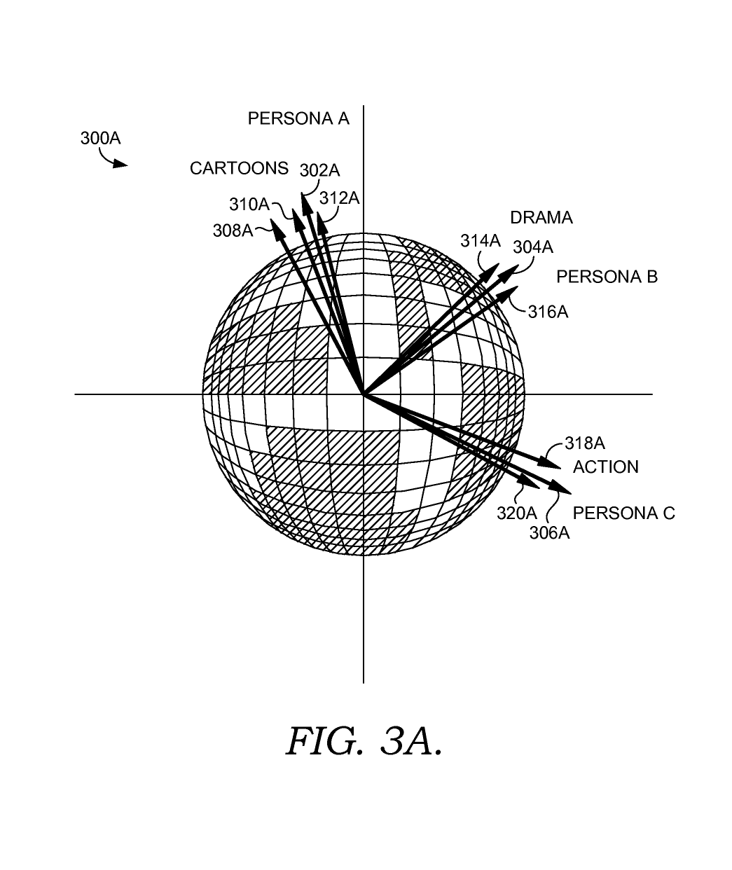

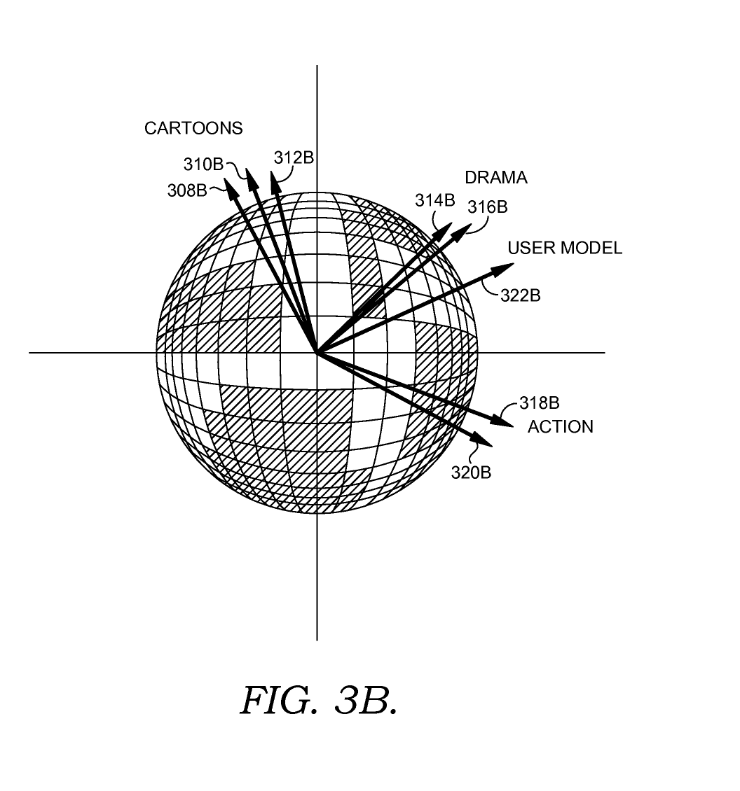

FIG. 3A provides an example of a latent space model 300A showing a number of taste vectors 302A, 304A, 306A generated for a particular user profile using multiple persona based modeling employing an embodiment of the present invention. In the present example, the user history for the user profile includes seven videos watched via the user profile, including three cartoon videos, two drama videos, and two action videos. Note that these labels are provided here for illustrative/discussion purposes only. In practice, the videos (or other items) may not have labels (such as type of movie genre) or other metadata. Instead, similarity amongst the items is based on the item vectors' locations in the latent space of the item model independent of any metadata.

As can be understood, the present example is a simplified fact scenario, and in practice, the user history for a user profile may have a much larger number of items. Based on an item model built around a plurality of user profiles (e.g., using the item model component 218 of FIG. 2), item vectors are available for each of the videos. As shown in FIG. 3A, the item vectors 308A, 310A, 312A, 314A, 316A, 318A, 320A are shown in the latent space model 300A. The item vectors 308A, 310A, 312A correspond with the three cartoon videos; the item vectors 314A, 316A correspond with the two drama videos; and the item vectors 318A, 320A correspond with the two action videos. As noted above, the labels provided here are for illustrative/discussion purposes only as the item vectors' location in the latent space model 300A may be used for clustering purposes without the use of any labels or other metadata. By grouping the item vectors 308A, 310A, 312A, 314A, 316A, 318A, 320A into clusters (e.g., using the item vector clustering component 204 of FIG. 2), three clusters have been identified and a taste vector has been generated for each cluster. The taste clusters 302A, 304A, 306A are shown in the latent space model 300A. The first taste cluster 302A corresponds with the cluster of item vectors 308A, 310A, 312A representing the three cartoon videos. The second taste cluster 304A corresponds with the cluster of item vectors 314A, 316A representing the two drama videos. The third taste cluster 306A corresponds with the cluster of item vectors 318A, 320A representing the two action videos.

By generating the three taste vectors 302A, 304A, 306A based on clusters of item vectors, video recommendations may be selected that better represent the different tastes of user(s) associated with the user profile. For instance, cartoon video recommendations may be selected based on the taste vector 302A, drama video recommendations may be selected based on the taste vector 304A, and action video recommendations may be selected based on the taste vector 306A. Accordingly, a variety of different recommendations may be provided that correspond with the different taste vectors 302A, 304A, 306A. This can be contrasted with the latent space model 300B of FIG. 3B, in which only a single user model vector 322B is generated based on the seven item vectors 308A, 310A, 312A, 314A, 316A, 318A, 320A. As shown in FIG. 3B, the user model vector 322B will not result in recommendations being selected for each of the three distinct types of videos being watched by the user(s) associated with the use profile.

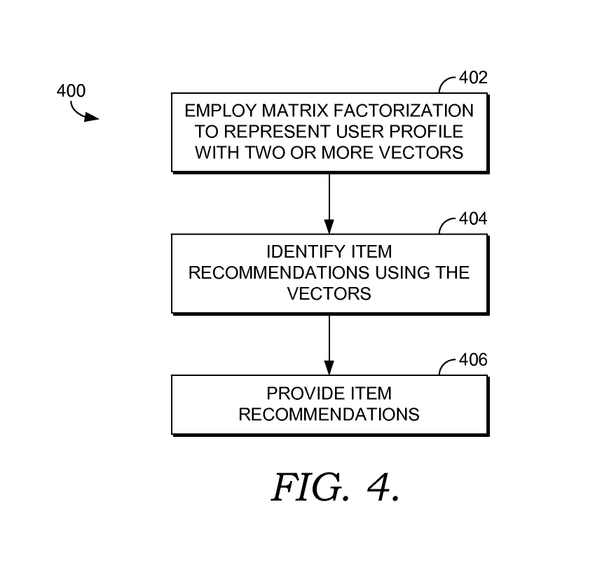

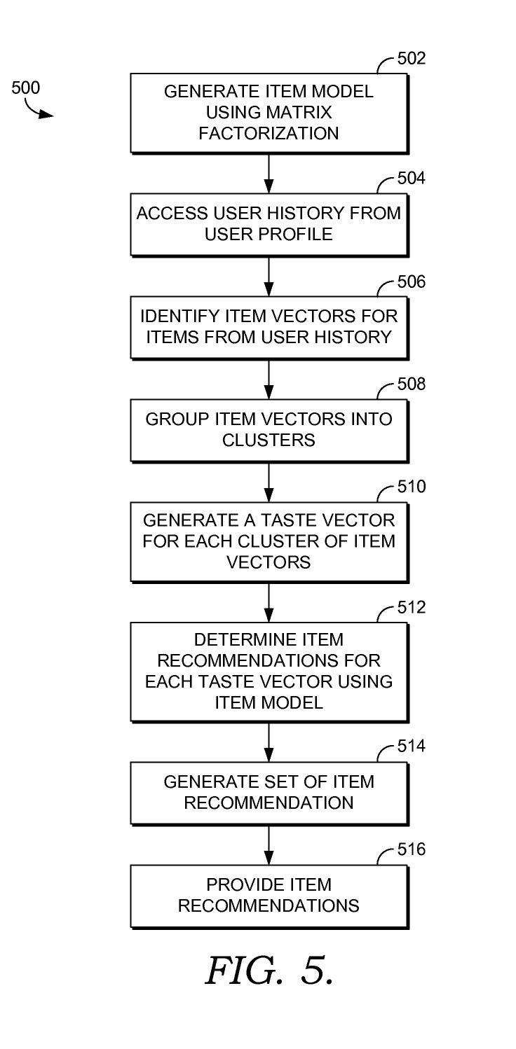

Turning now to FIG. 4, a flow diagram is provided that illustrates an overall method 400 for employing multiple taste vectors to provide item recommendations in accordance with an embodiment of the present invention. The method 400 may be employed to select item recommendations for any of a number of different types of items. Initially, as shown at block 402 matrix factorization is employed to represent a user profile with one or more vectors. One process for generating the vectors using matrix factorization was discussed in further detail above with reference to FIG. 2 and will also be discussed below with reference to FIG. 5. Item recommendations are identified using the vectors, as shown at block 404. Generally, each vector may be used to individually select item recommendations, and the item recommendations selected for each vector may be combined into a set of item recommendations. The set of item recommendations may then be provided for presentation to a user associated with the user profile, as shown at block 406.

With reference to FIG. 5, a flow diagram is provided that shows a more detailed method 500 for generating multiple taste vectors for a user profile and employing the multiple taste vectors to provide item recommendations in accordance with an embodiment of the present invention. As shown at block 502, an item model is generated using matrix factorization. The item model represents a number of different items using item vectors in a latent space. As noted above, an item model may be generated for any type of items for which recommendations may be provided. In some embodiments, the item model may be generated based on user history information that includes information regarding items consumed by users. In other embodiments, other information may be employed, such as item metadata.

User history information is accessed from a user profile, as shown at block 504. The user history information identifies items that have been consumed by one or more individuals using the user profile. As noted above, consumption of an item may include any type of interaction by a user with an item that provides an indication the user may be interested or disinterested in the item, such as, for instance, purchasing, renting, downloading, streaming, providing a review, and/or providing an indication of an item as a “like” or “dislike.” In some instances, the user profile may be associated with a single person, and the user history information identifies items consumed by that single person. In other instances, the user profile may be associated with a group of people. For example, the user profile may be a family profile in which multiple members of a family (e.g., parents and children) use the user profile. In such instances in which multiple people use a single user profile, the user history information identifies items consumed by each person using that user profile. The user history information, however, may not identify which users have consumed which items. Instead, the items may simply be associated with the user profile.

As shown at block 506, item vectors from the item model generated at block 502 are identified for items from the user history information accessed at block 504. Those item vectors are grouped into clusters, as shown at block 508. One clustering technique will described in detail below, but it should be understood that any of a variety of different clustering techniques may be employed within the scope of embodiments of the present invention.

A taste vector is generated for each cluster of item vectors, as shown at block 510. As such, there is a one-to-one correspondence between taste vectors and clusters. Each taste vector may be generated, for instance, as an average of the item vectors from a corresponding cluster. As shown at block 512, item recommendations are identified for each taste vector. Generally, each taste vector may be considered independently from other taste vectors to select item recommendations. Item recommendations may be identified for a given taste vector using item vectors from the item model generated at block 502. For instance, items may be ranked for a taste vector by computing the dot-product between the taste vector and each of a number of different item vectors from the item model. Item recommendations may be selected based on the dot-product results. The higher the dot-product result computed using an item vector for an item, the more relevant the item is considered to the taste vector. Accordingly, one or more item recommendations may be selected for a taste vector based on the rankings. Other factors may also be taken into consideration when selecting item recommendations.

A set of item recommendations may be generated based on the item recommendations identified for each taste vector, as shown at block 514. Generally, item recommendations for each taste vector may be selected and included in the set of item recommendations using any of a number of different approaches. In some instances, an equal number of item recommendations may be included for each taste vector. In other instances, weighting may be applied such that a different proportion of item recommendations are included for each taste vector. The weighting may be based on any of a number of different factors. For instance, the weighting may be based on the number of item vectors included in the cluster used to generate each taste vector. As another example, the weighting may be based on the strength or popularity of items in the cluster used to generate each taste vector. The strength or popularity of an item could be based, for instance, on the number of users that have consumed the item or user review/ratings of the item (e.g., number of stars given by users). As a further example, a time-based weighting may be applied in which the times at which each item was consumed is taken into consideration with the time at which the item recommendations are being provided.

The item recommendations from each taste vector may also be combined in the set of recommendations in any of a number of different ways. In some instances, the item recommendations may be separated into different groups corresponding with the taste vectors. In other instances, the item recommendations from each taste vector may be commingled, either in a single list or in several groupings in which the groupings correspond with some factor other than the taste vectors (e.g., grouping based on metadata, such as movie genre for movie recommendations). Item recommendations may also be ranked and ordered within the set of item recommendations using any of a number of different factors, such as strength of relevance of an item to a taste vector or the strength/popularity of an item based on overall user consumption/reviews/etc.

The set of item recommendations is provided for presentation to a user associated with the user profile, as shown at block 516. The set of item recommendations may be provided in any of a number of different environments using any of a number of delivery techniques. By way of example only and not limitation, item recommendations may be delivered: to an application used to consume items (e.g., a video streaming app, music streaming app, etc.), on a webpage (e.g., a user profile webpage of a web service used by the user), or via an email.

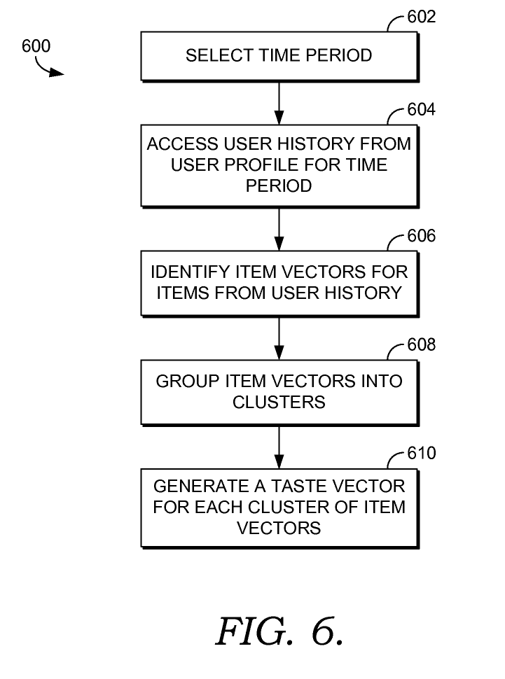

Turning now to FIG. 6, a flow diagram is provided that illustrates a method for generating taste vectors for item recommendation selection based on a time at which the item recommendations are being provided to a user in accordance with an embodiment of the present invention. As shown at block 602, a time period is selected. Any time period may be employed within the scope of embodiments of the present invention. For instance, the time period may simply be the day of the week or a weekday versus a weekend day. As another example, the time period may be a time of day, such as a time period of 1, 2, or more hours. The time period could also be a mix of day of the week and time of day. For instance, a time period could correspond with a 2 hour window on weekdays (i.e., the weekends would be excluded from the time period). The time period could also be based on holidays or other time-based information. Any and all such combinations and variations are contemplated to be within the scope of embodiments of the present invention.

As shown at block 604, user history information is accessed from a user profile for the selected time period. This includes identifying items that have been consumed by one or more users associated with the user profile during the selected time period. For instance, if the time period is between 2:00 pm and 4:00 pm on weekdays, only items that have been consumed during that time period are identified from the user profile.

Item vectors for each of the items identified at block 604 are identified from an item model (such as the item model 218 generated using the item model component 202 of FIG. 2). The item vectors are grouped into clusters, as shown at block 608, and a taste vector is generated for each cluster of item vectors, as shown at block 610.

The method 600 may be performed either on-the-fly when item recommendations are being provided or as a backend process. If performed on-the-fly when item recommendations are being provided, the time period selected at block 602 may be selected based on the time at which the item recommendations are being given. For instance, if the item recommendations are being given at 3:00 pm on a weekday, the time period may be selected as 2:00 pm-4:00 pm on weekdays. The taste vectors generate at block 610 may then be used to selected item recommendations, for instance, using the steps 512, 514, and 516 of FIG. 5.

If the method 600 is performed as a backend process, a number of different time periods may be selected, and the method may be performed for each of the different time periods. As a result, a set of taste vectors may be generated for each of the different time periods, and each set of taste vectors may be stored with an indication of the corresponding time period. When item recommendations are to be provided, a time period based on when the item recommendations are being provided may be selected and the set of taste vectors for that time period may be retrieved from storage. For instance, the time periods may include two-hour windows of time (e.g., 12:00 am-2:00 am; 2:00 am-4:00 am; etc.), and a set of taste vectors generated and stored for each two-hour window of time. When item recommendations are being provided, a two-hour window of time corresponding with when the item recommendations are being provided may be selected. Taste vectors for that two-hour window may be retrieved and used to select item recommendations, for instance using the steps 512, 514, and 516 of FIG. 5.

One specific approach to clustering item vectors to generate taste vectors will now be described. As noted above, taste vectors may be generated for a user profile based on user history information for the user profile. Let the user history be a set of item indexes:

[symbol]

={1,2, . . . N}

A tuple (vₙ,bₙ,yₙ,sₙ) may be associated with each item n. It is assumed that a user has N items in the user history. Each tuple may contain: the latent item vector vₙε [symbol] ^{K}, which follows a Gaussian approximation vₙ˜ [symbol] (vₙ; μₙ,Σₙ); the latent item bias bₙ, which follows a one-dimensional Gaussian approximation; the class yₙε{−1,+1}, specifying whether the user liked (or disliked) item n; and a confidence (variance) strength sₙ>0 on the latent signal. The system may use K=20 latent dimensions.

The user history H may be split into two sets:

[symbol]

ₗᵢₖₑ={nε [symbol] ;yₙ=+1}

[symbol]

_{dislike}={nε [symbol] ;yₙ=−1}

Each item in [symbol] ₗᵢₖₑ may be used to determine the user taste grouping. As a second stage, items from [symbol] _{dislike} may be added to the appropriate taste groups. The reason for determining taste groupings only on [symbol] ₗᵢₖₑ is that it guarantees that a group is not provided with only disliked items and a recommendation with an explanation “we recommend X because you disliked Y” will not be provided because each group will contain at least one liked item.

The history [symbol] ₗᵢₖₑ may be clustered based on inner products, as inner products may be used for scoring and recommending items. However, clustering may employ a valid distance metric, and one may be obtained by defining the normalized “mean item vector:”

$${x}_{n} = \frac{{μ}_{n}}{‖ {μ}_{n} ‖}$$

$$when$$

$${y}_{n} = + 1.$$

The clusters may be indexed by c=1, . . . , C, where C=maxTastes. If there are less items than maxTastes, or if two clusters are identical or close within e and are collapsed, then C<maxTastes.

Each cluster c will have a mean direction m_{c}.

To include the notion of a cluster width, a parameter β is introduced, which can specify how “far-reaching” a cluster can be. The probability of some to belong to cluster c may be defined as:

p_{c}(x)=p_{c}(x;m_{c},β)∝exp{βm_{c}^{T}x}.

This is the von Mises-Fisher distribution in directional statistics. It is a probability distribution on the (K−1)-dimensional sphere in [symbol] ^{K}. Its parameters are: the mean direction m_{c}; and the concentration parameter β.

Clustering may be performed in some embodiments using expectation maximization (EM). For each item n in [symbol] ₗᵢₖₑ, a cluster allocation probability vector may be defined as:

πₙ=(πₙ₁,πₙ₂, . . . ,π_{nC})

on the C-dimensional probability simplex. We have

Σₑ₌₁^{c}π_{nc}=1

and πₙ indicates what the odds are for xₙ to belong to each cluster c=1, . . . , C.

The output will be a set of taste clusters,

Tᵢ={(vₙ,bₙ,yₙ,sₙ)}

An EM algorithm may be initialized: For c=1, . . . , C, assign m_{c}=x_{c}, or set m_{c} randomly in the unit ball in [symbol] ^{K}.

E- and M-steps are repeated until convergence. The E-step includes updating the cluster assignments:

For each n in [symbol] ₗᵢₖₑ, set

π_{nc}′←exp{βm_{c}^{T}xₙ}

for c=1, . . . , C, to get unnormalized π_{nc}′. Normalize

$${π}_{nc} ← \frac{{π}_{nc}^{′}}{{\sum }_{c = 1}^{C} {π}_{nc}^{′}}$$

For this, the log-max trick for stable normalization may be done, as exp{ } divisions can be outside machine precision.

The M-step includes updating the direction vectors. For c=1, . . . , C, let

m_{c}′←Σ_{nε} [symbol] _{ₗᵢₖₑ}π_{nc}xₙ

and normalize to let m_{c} lie on the unit ball:

$${m}_{c} ← \frac{{m}_{c}^{′}}{‖ {m}_{c}^{′} ‖}$$

It can be shown that this is the correct update by adding a unit-ball Lagrange multiplier constraint to the Maximization step formulation.

Pruning may be also performed. For c=1, . . . , C:

If ∥m_{c}−m_{c}′∥<ε for some cluster, prune cluster c′ from list of clusters, leaving C←C−1.

Allocation includes, for each n in Hₗᵢₖₑ, setting the taste cluster allocation to

$$i ← {argmax }_{c} {π}_{nc}$$

and add

Tᵢ←{Tᵢ,(vₙ,bₙ,yₙ,sₙ)}

Each item n in Hₗᵢₖₑ now belongs to a taste cluster. Negative items may also be allocated to taste clusters. There are a number of options to now allocate the negative items to clusters.

One allocation method includes, for each item n in H_{dislike}:

$${x}_{n} = - \frac{{μ}_{n}}{‖ {μ}_{n} ‖}$$

$$when$$

$${y}_{n} = - 1$$

and allocate the item to taste cluster

$$i ← {argmax }_{c} {m}_{C}^{T} {x}_{n}$$

and add

Tᵢ←{Tᵢ,(vₙ,bₙ,yₙ,sₙ)}

Another allocation method includes, for each item n in H_{dislike}, add:

$${T}_{i} ← \{ {T}_{i} , ( {v}_{n} , {b}_{n} , {y}_{n} , \frac{{s}_{n}}{C} ) \}$$

to every taste cluster t. This says that a negative item is distributed equally across all tastes.

User models may be trained by, for each taste i, simply training the taste model with “taste history” Tᵢ.

As can be understood, embodiments of the present invention provide for analyzing usage information for a user profile to implicitly identify different tastes and provide item recommendations for each of those tastes. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
generating an item model using matrix factorization and user history information for a plurality of users profiles, the item model including a plurality of item vectors, each item vector representing an item;
accessing user history information identifying a plurality of items for a first user profile;
employing information from the item model and user history information to group item vectors corresponding with the plurality of items from the user history information into one or more clusters of item vectors;
generating a taste vector for each cluster of item vectors to provide one or more taste vectors;
identifying one or more item recommendations for each taste vector;
providing a set of item recommendations based on the one or more item recommendations for each taste vector; and
providing the set of item recommendation for presentation to a user associated with the first user profile.

2. The one or more computer storage media of claim 1, wherein the item model is generated also using item metadata.

3. The one or more computer storage media of claim 1, wherein the user history information includes information regarding when each of the plurality of items was consumed by one or more users associated with the first user profile.

4. The one or more computer storage media of claim 3, wherein accessing the user history information comprises accessing information regarding items consumed by the one or more users associated with the first user profile during a particular time period.

5. The one or more computer storage media of claim 1, wherein the item vectors are grouped into clusters using expectation maximization.

6. The one or more computer storage media of claim 1, wherein identifying the one or more item recommendations for each taste vector comprises, repeating for each taste vector:
selecting one of the taste vectors to provide a selected taste vector; and
ranking items for the selected taste vector based on the selected taste vector and item vectors for the items.

7. The one or more computer storage media of claim 6, wherein ranking items for the selected taste vector comprises:
computing a dot-product for the selected taste vector and each of the item vectors; and
ranking the items for the selected taste vector based on the dot-product for each item.

8. The one or more computer storage media of claim 1, wherein providing the set of item recommendations based on the one or more item recommendations for each taste vector comprises providing an equal number of item recommendations in the set of item recommendations for each taste vector.

9. The one or more computer storage media of claim 1, wherein providing the set of item recommendations based on the one or more item recommendations for each taste vector comprises providing a number of item recommendations for each taste vector based on a weighting applied to each taste vector.

10. The one or more computer storage media of claim 9, wherein the weighting applied to each taste vector is based on a number of item vectors in the cluster of item vectors corresponding with each taste vector.

11. The one or more computer storage media of claim 9, wherein the weighting applied to each taste vector is based on a popularity of item vectors in the cluster of item vectors corresponding with each taste vector.

12. The one or more computer storage media of claim 9, wherein the weighting applied to each taste vector is based on time at which the set of recommendations is being provided and a time at which item vectors in the cluster of item vectors corresponding with each taste vector were consumed by one or more users associated with the first user profile.

13. The one or more computer storage media of claim 1, wherein the set of item recommendations includes a separate grouping of item recommendations for each taste vector.

14. The one or more computer storage media of claim 1, wherein the set of item recommendations includes item recommendations for each taste vector commingled together.

15. A method comprising:
employing, via a first computing process, matrix factorization to represent a user profile with one or more vectors;
identifying, via a second computing process, a plurality of item recommendations employing the one or more vectors; and
providing, via a third computing process, at least a portion of the item recommendations for presentation to a user associated with the user profile;
wherein the computing processes are performed by one or more computing devices.

16. The method of claim 15, wherein employing matrix factorization to represent a user profile with one or more vectors comprises:
identifying items consumed using the user profile;
identifying a set of item vectors from an item model that includes a plurality of item vectors that each represent an item from a catalog of items, each item vector from the set of item vectors corresponding with one of the items consumed using the user profile;
grouping the set of item vectors into one or more clusters of item vectors; and
generating the one or more vectors based on the one or more clusters of item vectors.

17. The method of claim 16, wherein identifying items consumed using the user profile comprises identifying items consumed during a time period corresponding with a time at which the item recommendations are being provided for presentation.

18. The method of claim 15, wherein identifying the plurality of item recommendations employing the one or more vectors comprises:
selecting item recommendations for each vector independent of other vectors; and
generating the plurality of item recommendations by combining item recommendations selected for each vector.

19. The method of claim 18, wherein generating the plurality of item recommendations by combining item recommendations selected for each vector comprises selecting a number of item recommendations for each vector based on a weighting applied to each vector.

20. A computerized system comprising:
one or more processors; and
one or more computer storage media storing a plurality of software components, the software components including:
an item model component that generates an item model comprising a plurality of item vectors using matrix factorization on user history information for a plurality of users;
an item vector clustering component that employs information from the item model and information from a user profile to group item vectors into one or more clusters of item vectors;
a taste vector component that generates a taste vector for each cluster of item vectors to provide at least two taste vectors for the user profile; and
a recommendation component that provides at least one recommendation for each taste vector.
